(19) United States
(12) Patent Application Publication
(10) Pub. No.: US 2023/0292805 A1
(43) Pub. Date: Sep. 21, 2023

(54) READY-TO-DRINK ENERGY BEVERAGE

(71) Applicant: G.O.A.T. Fuel, Inc., Plano, TX (US)

(72) Inventors: Jaqui Rice, Plano, TX (US); Trevion Gold, Plano, TX (US); Jerry Rice, Plano, TX (US)

(21) Appl. No.: 18/201,529

(22) Filed: May 24, 2023

Related U.S. Application Data
(63) Continuation of application No. 17/744,157, filed on May 13, 2022.
(60) Provisional application No. 63/188,211, filed on May 13, 2021.

(51) Int. Cl. A23L 31/00; A23L 2/38; A23L 33/15; A23L 2/52; A23L 2/60

(52) U.S. Cl. CPC A23L 31/00; A23L 2/38; A23L 33/15; A23L 2/52; A23L 2/60

(57) ABSTRACT

The application describes a ready-to-drink energy beverage product comprising Cordyceps (e.g., Cordyceps militaris). In some embodiments, the beverage product can include some or all of the following ingredients: caffeine, vitamin B, sugar, taurine, glucuronolactone; and/or water.

### CROSS REFERENCE TO RELATED APPLICATIONS

This application claims the benefit of, and priority to, U.S. Provisional Patent Application Ser. No. 63/188,211, filed May 13, 2021, the entire contents of which are hereby incorporated by reference in their entirety.

### FIELD OF THE INVENTION

The present disclosure is directed to a ready-to-drink energy beverage product. More particularly, the present disclosure is directed to a ready-to-drink energy beverage product comprising Cordyceps.

### BACKGROUND

Cordyceps is a genus of ascomycete fungi that primarily grows as an arthropod parasite. Cordyceps has been used in traditional Chinese medicine for the treatment of fatigue, sickness, kidney disease, and low sex drive.

Recent studies have suggested various health benefits of Cordyceps consumption including improved athletic performance (Xu Y F, Int J Med Mushrooms. 2016; 18(12):1083-1092.; Nagata A, et al., Jpn. J. Phy. Fitness Sports Med. 2006; 55 Suppl.:S145-S152.; Yi X, et al., Chin. J. Integr. Med. 2004; 10: 187-192.; Chen S, et al., J Altern Complement Med. 2010; 16(5):585-90.; Hirsch K R, et al., J Diet Suppl. 2017; 14(1):42-53.), antioxidant effects (Ji D B, et al., Phytother Res. 2009 (1):116-22.; Li X T, et al., Am J Chin Med. 2010; 38(6):1093-106.; Xiao J H, et al., Evid Based Complement Alternat Med. 2012:273435.), inhibition of tumor growth (Bizarro A, et al., Molecules. 2015; 20(8):13927-40.; Lee H H, et al., Daru. 2015;23(1):35.; Wu J Y, etal., Phytomedicine. 2007; 14(1):43-9.; Lee S, etal., J Microbiol. 2015; 53(7):468-74.), blood-glucose management (Lo H C, et al., Life Sci. 2004; 74(23):2897-908.; Liu C, et al., Oxid Med Cell Longev. 2016:9685257.; Yu S H, et al., J Diabetes Res. 2015:723190.), improved cardiovascular health (Liu X, et al., Acta Pharmacol Sin. 2014; 35(5):697-706.; Gao J, et al., Yao Xue Xue Bao. 2011; 46(6):669-76.), and anti-inflammatory effects (Kuo Y C, et al., Am J Chin Med. 1996; 24(2):111-25.; Kim K M, et al., Toxicol Appl Pharmacol. 2003; 190(1):1-8.; Weng S C, et al., J Ethnopharrnacol. 2002;83(1-2):79-85.; Park S Y, et al., Orient Pharm Exp Med. 2015; 15(1):7-12.).

Energy drinks are widely available on the market and are generally aimed at enhancing mental and physical performance. Energy drinks often contain caffeine, sugars or ephedra. The present disclosure provides an improved energy drink having the beneficial health effects of Cordyceps.

### SUMMARY OF THE INVENTION

The present disclosure provides ready-to-drink energy beverage products comprising Cordyceps, caffeine, vitamin B, less than 1.0 gram per liter of sugar, and at least one of taurine and glucuronolactone.

In some embodiments, a ready-to-drink energy beverage product of the present disclosures comprises (per liter): 0.001 to 1.5 g of Cordyceps militaris; 0.1 to 1.0 g of caffeine; 0.01 to 0.25 g of vitamin B; less than 1.0 g of sugar; at least one of 1.0 to 10 g of taurine, and 1.0 to 10 g of glucuronolactone; and 945 to 998 g of water.

In some embodiments the energy beverage product comprises, 0.01 to 1.0 g (per liter) of Cordyceps militaris. In certain embodiments, the energy beverage product comprises 0.1 to 0.5 g (per liter) of Cordyceps militaris. In certain embodiments, the energy beverage product comprises 0.14 g or 0.28 g (per liter) of Cordyceps militaris.

In some embodiments the energy beverage product of the present disclosure comprises 0.25 to 0.75 g (per liter) of caffeine. In certain embodiments, the energy beverage product comprises, 0.6 g (per liter) of caffeine.

In some embodiments the energy beverage product of the present disclosure comprises 0.025 to 0.1 g (per liter) of vitamin B. In certain embodiments, the energy beverage product comprises, 0.08 g (per liter) of vitamin B.

In some embodiments the energy beverage product of the present disclosure comprises less than 0.5 g (per liter) of sugar. In certain embodiments, the energy beverage product comprises no sugar.

In some embodiments the energy beverage product of the present disclosure comprises 2.5 to 7.5 g (per liter) of taurine. In certain embodiments, the energy beverage product comprises 3 g (per liter) of taurine.

In some embodiments the energy beverage product of the present disclosure comprises 1.0 to 5.0 g (per liter) of glucuronolactone. In certain embodiments, the energy beverage product comprises 1.5 g (per liter) of glucuronolactone.

In some embodiments the energy beverage product of the present disclosure comprises an artificial sweetener. In some embodiments, the energy beverage product comprises 0.1 to 1.0 g (per liter) of sucralose. In certain embodiments, the energy beverage product comprises 0.3 g (per liter) of sucralose. In some embodiments, the energy beverage product comprises 0.05 to 0.5 g (per liter) of acesulfame potassium. In certain embodiments, the energy beverage product comprises 0.1 g (per liter) of acesulfame potassium.

In some embodiments the energy beverage product of the present disclosure comprises 1.0 to 5.0 g (per liter) of citric acid. In certain embodiments, the energy beverage product comprises 3.6 g (per liter) of citric acid.

In some embodiments the energy beverage product of the present disclosure comprises 0.01 to 0.15 g (per liter) of tartaric acid. In certain embodiments, the energy beverage product comprises 0.1 g (per liter) of tartaric acid.

In some embodiments, the energy beverage product of the present disclosure comprises at least one flavoring selected from the group consisting of 82724 Natural Unicorn Type Flavor. 82270 Natural Cotton Candy Type Flavor, 82000 Natural Orange Flavor WONF, GNT Shade “Intense Pink” Powder, 82214 Natural Galaxy Burst Type Flavor, 82397 Natural Tropical Punch Type Flavor, Exberry Shade “Blue” Powder, 82492 Natural Blueberry Flavor WONF, 82169 Natural Lemonade Type Flavor, Exberry Shade “Grape Blue” Powder, 82726 Natural Peach Flavor WONF 82713 Natural Cherry Flavor WONF, 82714 Natural Pineapple Flavor WONF, Exberry Shade “Intense Pink” Powder, and Exberry Shade “Spicy Yellow” Powder.

In some embodiments, the energy beverage product of the present disclosure comprises carbonated water having 1 to 10 g (per liter) of CO₂.

### DETAILED DESCRIPTION

Disclosed herein, according to various embodiments, is a ready-to-drink energy beverage product comprising Cordyceps, caffeine, vitamin B, and at least one of taurine and glucuronolactone.

Cordyceps

The ready-to-drink energy beverage product disclosed herein comprises Cordyceps. The energy beverage product can comprise Cordyceps selected from any one or more of: Cordyceps acridophila, Cordyceps albocitrina, Cordyceps amoene-rosea, Cordyceps ampullaceal, Cordyceps bifusispora, Cordyceps blackwelliae, Cordyceps brasiliensis, Cordyceps cateniannulata, Cordyceps cateniobliqua, Cordyceps chiangdaoensis, Cordyceps cicadae, Cordyceps coccidioperitheciata, Cordyceps coleopterorum, Cordyceps confragosa, Cordyceps cuncunae, Cordyceps cylindrica, Cordyceps farinose, Cordyceps fratricida, Cordyceps fumosorosea, Cordyceps ghanensis, Cordyceps grylli, Cordyceps guangdongensis, Cordyceps gunnii, Cordyceps hepialidicola, Cordyceps hesleri, Cordyceps imagamiana, Cordyceps isarioides, Cordyceps javanica, Cordyceps kirkii, Cordyceps koreana, Cordyceps kurijimeansis, Cordyceps kyushuensis, Cordyceps lepidopterorum, Cordyceps locusticola, Cordyceps memorabilis, Cordyceps militaris, Cordyceps morakotii, Cordyceps nakazawai, Cordyceps nidus, Cordyceps ninchukispora, Cordyceps ningxiaensis, Cordyceps nirtolii, Cordyceps ochraceostromata, Cordyceps pleuricapitata, Cordyceps polyarthra, Cordyceps poprawskii, Cordyceps pruinose, Cordyceps pseudonelumboides, Cordyceps rosea, Cordyceps roseostromata, Cordyceps scarabaeucika, Cordyceps sinensis, Cordyceps spegazzinii, Cordyceps sphingum, Cordyceps submilitaris, Cordyceps taishanensis, Cordyceps takaomontana, and Cordyceps tenuipes. In particular embodiments, the energy beverage product disclosed herein comprises Cordyceps militaris.

In some embodiments, the ready-to-drink energy beverage product disclosed herein comprises about 0.001 to 1.5 g per liter (g/L) of Cordyceps. For example, in some embodiments, the energy beverage product comprises about 0.005 to about 1.5, about 0.01 to about 1.5, about 0.05 to about 1.5, about 0.1 to about 1.5, about 0.5 to about 1.5, about 1.0 to about 1.5, about 0.001 to about 1.0, about 0.005 to about 1.0, about 0.01 to about 1.0, about 0.05 to about 1.0, about 0.1 to about 1.0, about 0.5 to about 1.0, about 0.001 to about 0.5, about 0.005 to about 0.5, about 0.01 to about 0.5, about 0.05 to about 0.5, or about 0.1 to about 0.5 g/L of Cordyceps. In some embodiments, the energy beverage product comprises about 0.10, about 0.11, about 0.12, about 0.13, about 0.14, about 0.15, about 0.16, about 0.17, about 0.18, about 0.19, about 0.20, about 0.21, about 0.22, about 0.23, about 0.24, about 0.25, about 0.26, about 0.27, about 0.28, about 0.29, or about 0.30 g/L of Cordyceps. In particular embodiments, the energy beverage product comprises about 0.14 g/L or about 0.28 g/L of Cordyceps militaris.

In some embodiments, the ready-to-drink energy beverage product disclosed herein comprises about 0.0001% to 0.15% (weight/weight (w/w)) of Cordyceps. For example, in some embodiments, the energy beverage product comprises about 0.0005% to about 0.15%, about 0.001% to about 0.15%, about 0.005% to about 0.15%, about 0.01% to about 0.15%, about 0.05% to about 0.15%, about 0.1% to about 0.15%, about 0.0001% to about 0.1%, about 0.0005% to about 0.1%, about 0.001% to about 0.1%, about 0.005% to about 0.1%, about 0.01% to about 0.1%, about 0.05% to about 0.1%, about 0.0001% to about 0.05%, about 0.0005% to about 0.05%, about 0.001% to about 0.05%, about 0.005% to about 0.05%, or about 0.01% to about 0.05% (w/w) of Cordyceps. In some embodiments, the energy beverage product comprises about 0.010%, about 0.011%, about 0.012%, about 0.013%, about 0.014%, about 0.015%, about 0.016%, about 0.017%, about 0.018%, about 0.019%, about 0.020%, about 0.021%, about 0.022%, about 0.023%, about 0.024%, about 0.025%, about 0.026%, about 0.027%, about 0.028%, about 0.029%, or about 0.030% (w/w) of Cordyceps. In particular embodiments, the energy beverage product comprises about 0.014% or about 0.028% (w/w) of Cordyceps militaris.

In some embodiments, preparations of the ready-to-drink energy beverage product of the present disclosure can be made with Cordyceps extract, wherein the extract may be concentrated; for example, two-times, three-times, four-times, five-times, ten-times, twenty-times, 50-times, or 100-times concentrated. When a ready-to-drink energy beverage product is prepared using Cordyceps extract, an amount of extract is added to the energy beverage product to yield an equivalent amount of unconcentrated Cordyceps. For example, if a ready-to-drink energy beverage product preparation comprises 0.14 g/L of Cordyceps, an equivalent product prepared with a five-times concentrated Cordyceps extract comprises 0.028 g/L of Cordyceps extract. Similarly, an equivalent product prepared with a ten-times concentrated Cordyceps extract comprises 0.014 g/L of Cordyceps extract.

### Caffeine

In some embodiments, the ready-to-drink energy beverage product disclosed herein comprises about 0.1 to 1.0 g/L of caffeine. For example, in some embodiments, the energy beverage product comprises about 0.15 to about 1.0, about 0.2 to about 1.0, about 0.25 to about 1.0, about 0.3 to about 1.0, about 0.35 to about 1.0, about 0.4 to about 1.0, about 0.45 to about 1.0, about 0.5 to about 1.0, about 0.55 to about 1.0, about 0.60 to about 1.0, about 0.65 to about 1.0, about 0.70 to about 1.0, about 0.75 to about 1.0, about 0.10 to about 0.75, 0.15 to about 0.75, about 0.2 to about 0.75, about 0.25 to about 0.75, about 0.3 to about 0.75, about 0.35 to about 0.75, about 0.4 to about 0.75, about 0.45 to about 0.75, about 0.5 to about 0.75, about 0.55 to about 0.75, about 0.60 to about 0.75, about 0.65 to about 0.75, or about 0.70 to about 0.75 g/L of caffeine. In some embodiments, the energy beverage product comprises about 0.10, about 0.15, about 0.20, about 0.25, about 0.30, about 0.35, about 0.40, about 0.45, about 0.50, about 0.51, about 0.52, about 0.53, about 0.54, about 0.55, about 0.56, about 0.57, about 0.58, about 0.59, about 0.60, about 0.65, about 0.70, about 0.75, about 0.80, about 0.85, about 0.90, about 0.95, or about 1.0 g/L of caffeine. In particular embodiments, the energy beverage product comprises about 0.6 g/L of caffeine.

In some embodiments, the ready-to-drink energy beverage product disclosed herein comprises about 0.01 to 0.1% (w/w) of caffeine. For example, in some embodiments, the energy beverage product comprises about 0.015% to about 0.1%, about 0.02% to about 0.1%, about 0.025% to about 0.1%, about 0.03% to about 0.1%, about 0.035% to about 0.1%, about 0.04% to about 0.1%, about 0.045% to about 0.1%, about 0.05% to about 0.1%, about 0.055% to about 0.1%, about 0.060% to about 0.1%, about 0.065% to about 0.1%, about 0.070% to about 0.1%, about 0.075% to about 0.1%, about 0.010% to about 0.075%, 0.015% to about 0.075%, about 0.02% to about 0.075%, about 0.025% to about 0.075%, about 0.03% to about 0.075, about 0.035% to about 0.075%, about 0.04% to about 0.075%, about 0.045% to about 0.075%, about 0.05% to about 0.075%, about 0.055% to about 0.075%, about 0.060% to about 0.075%, about 0.065% to about 0.075%, or about 0.070% to about 0.075% g/L of caffeine. In some embodiments, the energy beverage product comprises about 0.010%, about 0.015%, about 0.020%, about 0.025%, about 0.030%, about 0.035%, about 0.040%, about 0.045%, about 0.045%, about 0.050%, about 0.051%, about 0.052%, about 0.053%, about 0.054%, about 0.055%, about 0.056%, about 0.057%, about 0.058%, about 0.059%, about 0.060%, about 0.065%, about 0.070%, about 0.075%, about 0.080%, about 0.085%, about 0.090%, about 0.095%, or about 0.10% (w/w) of caffeine. In particular embodiments, the energy beverage product comprises about 0.056% or 0.057% (w/w) of caffeine.

### Vitamin B

The ready-to-drink energy beverage product disclosed herein can, in some embodiments, comprise B vitamins (“Vitamin B”). The energy beverage product can comprise Vitamin B selected from any one or more of: Vitamin B₁ (Thiamine), Vitamin B₂ (Riboflavin), Vitamin B₃ (Niacin, niacinamide, nicotinamide), Vitamin B₅ (Pantothenic acid), Vitamin B₆ (Pyridoxine, pyridoxamine), Vitamin B₇ (Biotin), Vitamin B₈ (Folate), and Vitamin B₁₂ (Cobalamin).

In some embodiments, the ready-to-drink energy beverage product disclosed herein comprises about 0.01 to 0.25 g/L of Vitamin B. For example, in some embodiments, the energy beverage product comprises about 0.015 to about 0.25, about 0.02 to about 0.25, about 0.025 to about 0.25, about 0.03 to about 0.25, about 0.035 to about 0.25, about 0.04 to about 0.25, about 0.045 to about 0.25, about 0.05 to about 0.25, about 0.055 to about 0.25, about 0.060 to about 0.25, about 0.065 to about 0.25, about 0.070 to about 0.25, about 0.075 to about 0.25, about 0.080 to about 0.25, 0.085 to about 0.25, about 0.090 to about 0.25, about 0.095 to about 0.25, about 0.10 to about 0.25, about 0.010 to about 0.1, about 0.015 to about 0.1, about 0.02 to about 0.1, about 0.025 to about 0.1, about 0.03 to about 0.1, about 0.035 to about 0.1, about 0.04 to about 0.1, about 0.045 to about 0.1, about 0.05 to about 0.1, about 0.055 to about 0.1, about 0.060 to about 0.1, about 0.065 to about 0.1, about 0.070 to about 0.1, about 0.075 to about 0.1, about 0.080 to about 0.1, 0.085 to about 0.1, about 0.090 to about 0.1, or about 0.095 to about 0.1 g/L of Vitamin B. In some embodiments, the energy beverage product comprises about 0.010, about 0.015, about 0.020, about 0.025, about 0.030, about 0.035, about 0.040, about 0.045, about 0.050, about 0.055, about 0.060, about 0.065, about 0.070, about 0.075, about 0.080, about 0.081, about 0.082, about 0.083, about 0.084, about 0.085, about 0.086, about 0.087, about 0.088, about 0.089, about 0.090, about 0.095, or about 0.10 g/L of Vitamin B. In particular embodiments, the energy beverage product comprises about 0.084 g/L of Vitamin B.

In some embodiments, the ready-to-drink energy beverage product disclosed herein comprises about 0.001% to 0.025% (w/w) of Vitamin B. For example, in some embodiments, the energy beverage product comprises about 0.0015% to about 0.025%, about 0.002% to about 0.025%, about 0.0025% to about 0.025%, about 0.003% to about 0.025%, about 0.0035% to about 0.025%, about 0.004% to about 0.025%, about 0.0045% to about 0.025%, about 0.005% to about 0.025%, about 0.0055% to about 0.025%, about 0.0060% to about 0.025%, about 0.0065% to about 0.025%, about 0.0070% to about 0.025%, about 0.0075% to about 0.025%, about 0.0080% to about 0.025%, 0.0085% to about 0.025%, about 0.0090% to about 0.025%, about 0.0095% to about 0.025%, about 0.010% to about 0.025%, about 0.0010% to about 0.01%, about 0.0015% to about 0.01%, about 0.002% to about 0.01%, about 0.0025% to about 0.01%, about 0.003% to about 0.01%, about 0.0035% to about 0.01%, about 0.004% to about 0.01%, about 0.0045% to about 0.01%, about 0.005% to about 0.01%, about 0.0055% to about 0.01%, about 0.0060% to about 0.01%, about 0.0065% to about 0.01%, about 0.0070% to about 0.01%, about 0.0075% to about 0.01%, about 0.0080% to about 0.01%, 0.0085% to about 0.01%, about 0.0090% to about 0.01%, or about 0.0095% to about 0.01% (w/w) of Vitamin B. In some embodiments, the energy beverage product comprises about 0.0010%, about 0.0015%, about 0.0020%, about 0.0025%, about 0.0030%, about 0.0035%, about 0.0040%, about 0.0045%, about 0.0050%, about 0.0055%, about 0.0060%, about 0.0065%, about 0.0070%, about 0.0075%, about 0.0080%, about 0.0081%, about 0.0082%, about 0.0083%, about 0.0084%, about 0.0085%, about 0.0086%, about 0.0087%, about 0.0088%, about 0.0089%, about 0.0090%, about 0.0095%, or about 0.010% (w/w) of Vitamin B. In particular embodiments, the energy beverage product comprises about 0.0083% or 0.0084% (w/w) of Vitamin B.

### Sugar

The ready-to-drink energy beverage product disclosed herein can, in some embodiments, comprise less that 1.0 g/L of sugar. As used herein, sugars include sucrose, liquid sucrose, fructose, liquid fructose, glucose, liquid glucose, glucose-fructose syrup from natural sources (e.g., apple, chicory, honey), high fructose corn syrup, invert sugar, maple syrup, maple sugar, honey, brown sugar molasses (e.g., cane molasses, such as first molasses, second molasses, blackstrap molasses, sugar beet molasses), sorghum syrup, and Lo Han Guo juice concentrate.

In some embodiments, the ready-to-drink energy beverage product disclosed herein comprises one or more artificial sweetener selected from sodium saccharin, calcium saccharin, acesulfame potassium, sodium cyclamate, calcium cyclamate, neohesperidin dihydrochalcone, sucralose, alitame, aspartame, sorbitol, mannitol, xylitol, glycyrrhizin, D-tagatose, erythritol, meso-erythritol, malitol, maltose, lactose, fructo-oligosaccharides, Lo Han Guo powder, mogroside V, glycyrrhizin, steviol glycosides (e.g., rebaudioside A, rebaudioside B, rebaudioside C, rebaudioside D, rebaudioside E, steviolbioside, stevioside, dulcoside A), Stevia rebaudiana extract, xylose, arabinose, isomalt, lactitol, maltitol, trehalose, ribose, and protein sweeteners (e.g., monatin, thaumatin, monellin, brazzein, D-alanine, and glycine).

In some embodiments, the ready-to-drink energy beverage product disclosed herein comprises about 0.1 to about 1.0 g/L of sucralose. For example, in some embodiments, the energy beverage comprises about 0.2 to about 1.0, about 0.3 to about 1.0, about 0.4 to about 1.0, about 0.5 to about 1.0, about 0.6 to about 1.0, about 0.7 to about 1.0, about 0.8 to about 1.0, about 0.9 to about 1.0, about 0.1 to about 0.5, about 0.2 to about 0.5, about 0.3 to about 0.5, and about 0.4 to about 0.5 g/L of sucralose. In some embodiments, the energy beverage comprises about 0.1, about 0.2, about 0.3, about 0.4, about 0.5, about 0.6, about 0.7, about 0.8, about 0.9, or about 1.0 g/L of sucralose. In particular embodiments, the energy beverage product comprises about 0.3 g/L of sucralose.

In some embodiments, the ready-to-drink energy beverage product disclosed herein comprises about 0.01% to about 0.1% (w/w) sucralose. For example, in some embodiments, the energy beverage comprises about 0.02% to about 0.1%, about 0.03% to about 0.1%, about 0.04% to about 0.1%, about 0.05% to about 0.1%, about 0.06% to about 0.1%, about 0.07% to about 0.1%, about 0.08% to about 0.1%, about 0.09% to about 0.1%, about 0.01% to about 0.05%, about 0.02% to about 0.05%, about 0.03% to about 0.05%, and about 0.04% to about 0.05% (w/w) of sucralose. In some embodiments, the energy beverage comprises about 0.01%, about 0.02%, about 0.03%, about 0.04%, about 0.05%, about 0.06%, about 0.07%, about 0.08%, about 0.09%, or about 0.1% (w/w) of sucralose. In particular embodiments, the energy beverage product comprises about 0.02% or 0.03% (w/w) of sucralose.

In some embodiments, the ready-to-drink energy beverage product disclosed herein comprises about 0.05 to about 0.5 g/L of acesulfame potassium. For example, in some embodiments, the energy beverage comprises about 0.075 to about 0.5, about 0.1 to about 0.5, about 0.15 to about 0.5, about 0.2 to about 0.5, about 0.25 to about 0.5, about 0.3 to about 0.5, about 0.35 to about 0.5, about 0.4 to about 0.5, about 0.45 to about 0.5, about 0.05 to about 0.25, about 0.075 to about 0.25, about 0.1 to about 0.25, about 0.15 to about 0.25, or about 0.2 to about 0.25 g/L of acesulfame potassium. In some embodiments, the energy beverage comprises about 0.10, about 0.11, about 0.12, about 0.13, about 0.14, about 0.15, about 0.16, about 0.17, about 0.18, about 0.19, about 0.2, about 0.25, about 0.3, about 0.35, about 0.4, about 0.45, or about 0.5 g/L of acesulfame potassium. In particular embodiments, the energy beverage product comprises about 0.11 g/L of acesulfame potassium.

In some embodiments, the ready-to-drink energy beverage product disclosed herein comprises about 0.005% to about 0.05% (w/w) of acesulfame potassium. For example, in some embodiments, the energy beverage comprises about 0.0075% to about 0.05%, about 0.01% to about 0.05%, about 0.015% to about 0.05%, about 0.02% to about 0.05%, about 0.025% to about 0.05%, about 0.03% to about 0.05%, about 0.035% to about 0.05%, about 0.04% to about 0.05%, about 0.045% to about 0.05%, about 0.005% to about 0.025%, about 0.0075% to about 0.025%, about 0.01% to about 0.025%, about 0.015% to about 0.025%, or about 0.02% to about 0.025% (w/w) of acesulfame potassium. In some embodiments, the energy beverage comprises about 0.010%, about 0.011%, about 0.012%, about 0.013%, about 0.014%, about 0.015%, about 0.016%, about 0.017%, about 0.018%, about 0.019%, about 0.02%, about 0.025%, about 0.03%, about 0.035%, about 0.04%, about 0.045%, or about 0.05% (w/w) of acesulfame potassium. In particular embodiments, the energy beverage product comprises about 0.011% (w/w) of acesulfame potassium.

### Taurine

In some embodiments, the ready-to-drink energy beverage product disclosed herein comprises about 1.0 to about 10 g/L of taurine. For example, in some embodiments, the energy beverage comprises about 1.5 to about 10, about 2.0 to about 10, about 2.5 to about 10, about 3.0 to about 10, about 3.5 to about 10, about 4.0 to about 10, about 4.5 to about 10, about 5.0 to about 10, about 5.5 to about 10, about 6.0 to about 10, about 6.5 to about 10, about 7.0 to about 10, about 7.5 to about 10, about 1.0 to about 7.5, about 1.5 to about 7.5, about 2.0 to about 7.5, about 2.5 to about 7.5, about 3.0 to about 7.5, about 3.5 to about 7.5, about 4.0 to about 7.5, about 4.5 to about 7.5, about 5.0 to about 7.5, about 5.5 to about 7.5, about 6.0 to about 7.5, about 6.5 to about 7.5, about 7.0 to about 7.5, about 1.0 to about 5.0, about 1.5 to about 5.0, about 2.0 to about 5.0, about 2.5 to about 5.0, about 3.0 to about 5.0, about 3.5 to about 5.0, about 4.0 to about 5.0, or about 4.5 to about 5.0 g/L of taurine. In some embodiments, the energy beverage comprises about 1.0, about 2.0, about 3.0, about 3.1, about 3.2, about 3.3, about 3.4, about 3.5, about 3.6, about 3.7, about 3.8, about 3.9, about 4.0, about 5.0, about 6.0, about 7.0, about 8.0, about 9.0, or about 10 g/L of taurine. In particular embodiments, the energy beverage product comprises about 3.1 or about 3.2 g/L of taurine.

In some embodiments, the ready-to-drink energy beverage product disclosed herein comprises about 0.1% to about 1% (w/w) of taurine. For example, in some embodiments, the energy beverage comprises about 0.15% to about 1%, about 0.2% to about 1%, about 0.25% to about 1%, about 0.3% to about 1%, about 0.35% to about 1%, about 0.4% to about 1%, about 0.45% to about 1%, about 0.5% to about 1%, about 0.55% to about 1%, about 0.6% to about 1%, about 0.65% to about 1%, about 0.7% to about 1%, about 0.75% to about 1%, about 0.1% to about 0.75%, about 0.15 to about 0.75%, about 0.2% to about 0.75%, about 0.25% to about 0.75%, about 0.3% to about 0.75%, about 0.35% to about 0.75%, about 0.4% to about 0.75%, about 0.45% to about 0.75%, about 0.5% to about 0.75%, about 0.55% to about 0.75%, about 0.6% to about 0.75%, about 0.65% to about 0.75%, about 0.7% to about 0.75%, about 0.1% to about 0.5%, about 0.15% to about 0.5%, about 0.2% to about 0.5%, about 0.25% to about 0.5%, about 0.3% to about 0.5%, about 0.35% to about 0.5%, about 0.4% to about 0.5%, or about 0.45% to about 0.5% (w/w) of taurine. In some embodiments, the energy beverage comprises about 0.1%, about 0.2%, about 0.30%, about 0.31%, about 0.32%, about 0.33%, about 0.34%, about 0.35%, about 0.36%, about 0.37%, about 0.38%, about 0.39%, about 0.4%, about 0.5%, about 0.6%, about 0.7%, about 0.8, about 0.9%, or about 1% (w/w) of taurine. In particular embodiments, the energy beverage product comprises about 0.31% or about 0.32% (w/w) of taurine.

### Glucuronolactone

In some embodiments, the ready-to-drink energy beverage product disclosed herein comprises about 1.0 to about 10 g/L of glucuronolactone. For example, in some embodiments, the energy beverage comprises about 1.5 to about 10, about 2.0 to about 10, about 2.5 to about 10, about 3.0 to about 10, about 3.5 to about 10, about 4.0 to about 10, about 4.5 to about 10, about 5.0 to about 10, about 5.5 to about 10, about 6.0 to about 10, about 6.5 to about 10, about 7.0 to about 10, about 7.5 to about 10, about 1.0 to about 7.5, about 1.5 to about 7.5, about 2.0 to about 7.5, about 2.5 to about 7.5, about 3.0 to about 7.5, about 3.5 to about 7.5, about 4.0 to about 7.5, about 4.5 to about 7.5, about 5.0 to about 7.5, about 5.5 to about 7.5, about 6.0 to about 7.5, about 6.5 to about 7.5, about 7.0 to about 7.5, about 1.0 to about 5.0, about 1.5 to about 5.0, about 2.0 to about 5.0, about 2.5 to about 5.0, about 3.0 to about 5.0, about 3.5 to about 5.0, about 4.0 to about 5.0, or about 4.5 to about 5.0 g/L of glucuronolactone. In some embodiments, the energy beverage comprises about 1.0, about 1.1, about 1.2, about 1.3, about 1.4, about 1.5, about 1.6, about 1.7, about 1.8, about 1.9, about 2.0, about 3.0, about 4.0, about 5.0, about 6.0, about 7.0, about 8.0, about 9.0, or about 10 g/L of glucuronolactone. In particular embodiments, the energy beverage product comprises about 1.4 or about 1.5 g/L of glucuronolactone.

In some embodiments, the ready-to-drink energy beverage product disclosed herein comprises about 0.1% to about 1% (w/w) of glucuronolactone. For example, in some embodiments, the energy beverage comprises about 0.15% to about 1%, about 0.2% to about 1%, about 0.25% to about 1%, about 0.3% to about 1%, about 0.35% to about 1%, about 0.4% to about 1%, about 0.45% to about 1%, about 0.5% to about 1%, about 0.55% to about 1%, about 0.6% to about 1%, about 0.65% to about 1%, about 0.7% to about 1%, about 0.75% to about 1%, about 0.1% to about 0.75%, about 0.15 to about 0.75%, about 0.2% to about 0.75%, about 0.25% to about 0.75%, about 0.3% to about 0.75%, about 0.35% to about 0.75%, about 0.4% to about 0.75%, about 0.45% to about 0.75%, about 0.5% to about 0.75%, about 0.55% to about 0.75%, about 0.6% to about 0.75%, about 0.65% to about 0.75%, about 0.7% to about 0.75%, about 0.1% to about 0.5%, about 0.15% to about 0.5%, about 0.2% to about 0.5%, about 0.25% to about 0.5%, about 0.3% to about 0.5%, about 0.35% to about 0.5%, about 0.4% to about 0.5%, or about 0.45% to about 0.5% (w/w) of glucuronolactone. In some embodiments, the energy beverage comprises about 0.10%, about 0.11%, about 0.12%, about 0.13%, about 0.14%, about 0.15%, about 0.16%, about 0.17%, about 0.18%, about 0.19%, about 0.2%, about 0.3%, about 0.4%, about 0.5%, about 0.6%, about 0.7%, about 0.8, about 0.9%, or about 1% (w/w) of glucuronolactone. In particular embodiments, the energy beverage product comprises about 0.14% or about 0.15% (w/w) of glucuronolactone.

### Flavorings

In some embodiments, the ready-to-drink energy beverage product disclosed herein comprises one or more flavorings selected from phosphoric acid, citric acid, malic acid, tartaric acid, lactic acid, fumaric acid, ascorbic acid, gluconic acid, succinic acid, maleic acid, adipic acid, cinnamic acid, glutaric acid, formic acid.

In some embodiments, the ready-to-drink energy beverage product disclosed herein comprises about 1.0 to about 5.0 g/L of citric acid. For example, in some embodiments, the energy beverage comprises about 1.5 to about 5.0, about 2.0 to about 5.0, about 2.5 to about 5.0, about 3.0 to about 5.0, about 3.5 to about 5.0, about 4.0 to about 5.0, or about 4.5 to about 5.0 g/L of citric acid. In some embodiments, the energy beverage comprises about 1.0, about 2.0, about 3.0, about 3.1, about 3.2, about 3.3, about 3.4, about 3.5, about 3.6, about 3.7, about 3.8, about 3.9, about 4.0, or about 5.0 g/L of citric acid. In particular embodiments, the energy beverage product comprises about 3.6 g/L of citric acid.

In some embodiments, the ready-to-drink energy beverage product disclosed herein comprises about 0.1% to about 0.5% (w/w) of citric acid. For example, in some embodiments, the energy beverage comprises about 0.15% to about 0.5%, about 0.2% to about 0.5%, about 0.25% to about 0.5%, about 0.3% to about 0.5%, about 0.35% to about 0.5%, about 0.4% to about 0.5%, about 0.45% to about 0.5% (w/w) of citric acid. In some embodiments, the energy beverage comprises about 0.1%, about 0.2%, about 0.30%, about 0.31%, about 0.32%, about 0.33%, about 0.34%, about 0.35%, about 0.36%, about 0.37%, about 0.38%, about 0.39%, about 0.4%, about 0.5%, about 0.6%, about 0.7%, about 0.8, about 0.9%, or about 1% (w/w) of citric acid. In particular embodiments, the energy beverage product comprises about 0.36% (w/w) of citric acid.

In some embodiments, the ready-to-drink energy beverage product disclosed herein comprises about 0.01 to 0.15 g/L of tartaric acid. For example, in some embodiments, the energy beverage product comprises about 0.015 to about 0.15, about 0.02 to about 0.15, about 0.025 to about 0.15, about 0.03 to about 0.15, about 0.035 to about 0.15, about 0.04 to about 0.15, about 0.045 to about 0.15, about 0.05 to about 0.15, about 0.055 to about 0.15, about 0.060 to about 0.15, about 0.065 to about 0.15, about 0.070 to about 0.15, about 0.075 to about 0.15, about 0.080 to about 0.15, 0.085 to about 0.15, about 0.090 to about 0.15, about 0.095 to about 0.15, about 0.10 to about 0.15, or about 0.125 to about 0.15 g/L of tartaric acid. In some embodiments, the energy beverage product comprises about 0.010, about 0.011, about 0.012, about 0.013, about 0.014, about 0.015, about 0.016, about 0.017, about 0.018, about 0.019, about 0.020, about 0.025, about 0.030, about 0.035, about 0.040, about 0.045, about 0.050, about 0.055, about 0.060, about 0.065, about 0.070, about 0.075, about 0.080, about 0.085, about 0.090, about 0.095, about 0.10, or about 0.15 g/L of tartaric acid. In particular embodiments, the energy beverage product comprises about 0.11 g/L of tartaric acid.

In some embodiments, the ready-to-drink energy beverage product disclosed herein comprises about 0.001% to 0.015% (w/w) of tartaric acid. For example, in some embodiments, the energy beverage product comprises about 0.0015% to about 0.015%, about 0.002% to about 0.015%, about 0.0025% to about 0.015%, about 0.003% to about 0.015%, about 0.0035% to about 0.015%, about 0.004% to about 0.015%, about 0.0045% to about 0.015%, about 0.005% to about 0.015%, about 0.0055% to about 0.015%, about 0.0060% to about 0.015%, about 0.0065% to about 0.015%, about 0.0070% to about 0.015%, about 0.0075% to about 0.015%, about 0.0080% to about 0.015%, 0.0085% to about 0.015%, about 0.0090% to about 0.015%, about 0.0095% to about 0.015%, or about 0.010% to about 0.015% (w/w) of tartaric acid. In some embodiments, the energy beverage product comprises about 0.0010%, about 0.0011%, about 0.0012%, about 0.0013%, about 0.0014%, about 0.0015%, about 0.0016%, about 0.0017%, about 0.0018%, about 0.0019%, about 0.0020%, about 0.0025%, about 0.0030%, about 0.0035%, about 0.0040%, about 0.0045%, about 0.0050%, about 0.0055%, about 0.0060%, about 0.0065%, about 0.0070%, about 0.0075%, about 0.0080%, about 0.0085%, about 0.0090%, about 0.0095%, about 0.010%, or about 0.015% (w/w) of tartaric acid. In particular embodiments, the energy beverage product comprises about 0.11% (w/w) of tartaric acid.

In some embodiments, the ready-to-drink energy beverage product disclosed herein comprises at least one flavor selected from orange, lemon, lime, grapefruit, tangerine, mandarin orange, tangelo, pomelo, apple, grape, cherry, pineapple, 82724 Natural Unicorn Type Flavor. 82270 Natural Cotton Candy Type Flavor, 82000 Natural Orange Flavor WONF, GNT Shade “Intense Pink” Powder, 82214 Natural Galaxy Burst Type Flavor, 82397 Natural Tropical Punch Type Flavor, Exberry Shade “Blue” Powder, 82492 Natural Blueberry Flavor WONF, 82169 Natural Lemonade Type Flavor, Exberry Shade “Grape Blue” Powder, 82726 Natural Peach Flavor WONF 82713 Natural Cherry Flavor WONF, 82714 Natural Pineapple Flavor WONF, Exberry Shade “Intense Pink” Powder, and Exberry Shade “Spicy Yellow” Powder. For example, in an embodiment, the ready-to-drink energy beverage product disclosed herein comprises 82724 Natural Unicorn Type Flavor, 82270 Natural Cotton Candy Type Flavor, 82000 Natural Orange Flavor WONF, and GNT Shade “Intense Pink” Powder. In another embodiment, the ready-to-drink energy beverage product disclosed herein comprises 82214 Natural Galaxy Burst Type Flavor, 82397 Natural Tropical Punch Type Flavor, and Exberry Shade “Blue” Powder. In yet another embodiment, the ready-to-drink energy beverage product disclosed herein comprises 82492 Natural Blueberry Flavor WONF, 82169 Natural Lemonade Type Flavor, and Exberry Shade “Grape Blue” Powder. In still another embodiment, the ready-to-drink energy beverage product disclosed herein comprises 82726 Natural Peach Flavor WONF, 82713 Natural Cherry Flavor WONF, 82714 Natural Pineapple Flavor WONF, Exberry Shade “Intense Pink” Powder, and Exberry Shade “Spicy Yellow” Powder.

### Water

In some embodiments, the ready-to-drink energy beverage product disclosed herein comprises non-carbonated or carbonated water.

For example, in some embodiments the ready-to-drink energy beverage product disclosed herein comprises carbonated water having about 1 to about 10 g/L of dissolved carbon dioxide (CO₂). In some embodiments, the energy beverage product comprises water having about 1 to about 8, about 1 to about 6, about 1 to about 4, about 2 to about 10, about 2 to about 8, about 2 to about 6, about 2 to about 4, about 4 to about 10, about 4 to about 8, about 4 to about 6, about 6 to about 10, about 6 to about 8, or about 8 to about 10 g/L of dissolved CO₂.

### Energy Beverage Products

Ready-to-drink energy beverage products of the present disclosure comprise Cordyceps, caffeine, vitamin B, less than 1.0 g/L of sugar, at least one of taurine and glucuronolactone, and water.

In some embodiments, the energy beverage product comprises (per liter): 0.001 to 1.5 g of Cordyceps militaris; 0.1 to 1.0 g of caffeine; 0.01 to 0.25 g of vitamin B; less than 1.0 g of sugar; at least one of 1.0 to 10 g of taurine, and 1.0 to 10 g of glucuronolactone; and 945 to 998 g of water.

In certain embodiments, the energy beverage product comprises (per liter): 0.14 g of Cordyceps militaris; 0.6 g of caffeine; 0.08 g of vitamin B; no sugar; 3 g of taurine; 1.5 g of glucuronolactone; and 980 g of carbonated water.

In certain embodiments, the energy beverage product comprises (per liter): 0.14 g of Cordyceps militaris; 0.6 g of caffeine; 0.08 g of vitamin B; no sugar; 3 g of taurine; 1.5 g of glucuronolactone; 0.3 g of sucralose; 0.1 g of acesulfame potassium; 3.6 g of citric acid; and 980 g of carbonated water.

In certain embodiments, the energy beverage product comprises (per liter): 0.14 g of Cordyceps militaris; 0.6 g of caffeine; 0.08 g of vitamin B; no sugar; 3 g of taurine; 1.5 g of glucuronolactone; 0.3 g of sucralose; 0.1 g of acesulfame potassium; 3.6 g of citric acid; 0.1 g of tartaric acid; and 980 g of carbonated water.

In certain embodiments, the energy beverage product comprises (per liter): 0.14 g of Cordyceps militaris; 0.6 g of caffeine; 0.08 g of vitamin B; no sugar; 3 g of taurine; 1.5 g of glucuronolactone; 0.3 g of sucralose; 0.1 g of acesulfame potassium; 3.6 g of citric acid; 82724 Natural Unicorn Type Flavor; 82270 Natural Cotton Candy Type Flavor; 82000 Natural Orange Flavor WONF, GNT Shade “Intense Pink” Powder; and 980 g of carbonated water.

In certain embodiments, the energy beverage product comprises (per liter): 0.14 g of Cordyceps militaris; 0.6 g of caffeine; 0.08 g of vitamin B; no sugar; 3 g of taurine; 1.5 g of glucuronolactone; 0.3 g of sucralose; 0.1 g of acesulfame potassium; 3.6 g of citric acid; 82214 Natural Galaxy Burst Type Flavor, 82397 Natural Tropical Punch Type Flavor, Exberry Shade “Blue” Powder; and 980 g of carbonated water.

In certain embodiments, the energy beverage product comprises (per liter): 0.14 g of Cordyceps militaris; 0.6 g of caffeine; 0.08 g of vitamin B; no sugar; 3 g of taurine; 1.5 g of glucuronolactone; 0.3 g of sucralose; 0.1 g of acesulfame potassium; 3.6 g of citric acid; 0.1 g of tartaric acid; 82492 Natural Blueberry Flavor WONF, 82169 Natural Lemonade Type Flavor, Exberry Shade “Grape Blue” Powder; and 980 g of carbonated water.

In certain embodiments, the energy beverage product comprises (per liter): 0.14 g of Cordyceps militaris; 0.6 g of caffeine; 0.08 g of vitamin B; no sugar; 3 g of taurine; 1.5 g of glucuronolactone; 0.3 g of sucralose; 0.1 g of acesulfame potassium; 3.6 g of citric acid; 82726 Natural Peach Flavor WONF 82713 Natural Cherry Flavor WONF, 82714 Natural Pineapple Flavor WONF, Exberry Shade “Intense Pink” Powder, and Exberry Shade “Spicy Yellow” Powder; and 980 g of carbonated water.

### EXAMPLES

The disclosure now being generally described, will be more readily understood by reference to the following examples, which are included merely for purposes of illustration of certain aspects and embodiments of the present disclosure, and are not intended to limit the scope of the disclosure in any way.

### Example 1: “Pink Candy”-Flavored Ready-to-Drink Energy Beverage Product

A “pink candy”-flavored ready-to-drink energy beverage product was prepared by first mixing, in no particular order, caffeine, taurine, glucuronolactone, Vitamin B₂ (riboflavin), Vitamin B₃ (niacin, niacinamide, nicotinamide), Vitamin B₅ (pantothenic acid), Vitamin B₆ (pyridoxine, pyridoxamine), Vitamin B₇ (biotin), and Vitamin B₁₂ (cobalamin), to produce an Energy Premix powder according to the amounts in Table 1.

TABLE 1
Energy Premix Powder

| | Weight | Percent |
|---|---|---|
| | (g) | (w/w) |
| Caffeine | 0.2 | 7.1 |
| Taurine | 1.1 | 39 |
| Glucoronolactone | 0.53 | 19 |
| Vitamin B₂ (riboflavin) | 0.0013 | 0.046 |
| Vitamin B₃ (niacin, niacinamide, nicotinamide) | 0.015 | 0.53 |
| Vitamin B₅ (pantothenic acid) | 0.012 | 0.41 |
| Vitamin B₆ (pyridoxine, pyridoxamine) | 0.0015 | 0.053 |
| Vitamin B₇ (biotin) | 0.00022 | 0.0079 |
| Vitamin B₁₂ (cobalamin) | 0.0000045 | 0.00016 |

Next, Energy Premix powder was combined, in no particular order, with Cordyceps militaris, sucralose, acesulfame potassium, citric acid, 82724 Natural Unicorn Type Flavor, 82270 Natural Cotton Candy Type Flavor, 82000 Natural Orange Flavor WONF, GNT Shade “Intense Pink” Powder, and carbonated water to produce the “pink candy”-flavored ready-to-drink energy beverage product according to the amounts in Table 2.

TABLE 2
“Pink candy”-flavored ready-to-drink energy beverage product

| | Weight (g) per | |
|---|---|---|
| | Liter | Percent |
| | (L) | (w/w) |
| Energy Premix Powder | 8.0 | 0.80 |
| Cordyceps militaris | 0.14 | 0.014 |
| Sucralose | 0.29 | 0.029 |
| Acesulfame potassium | 0.11 | 0.011 |
| Citric acid | 3.6 | 0.36 |
| 82724 Natural Unicorn Type Flavor | 4.9 | 0.49 |
| 82270 Natural Cotton Candy Type Flavor | 1.2 | 0.12 |
| 82000 Natural Orange Flavor WONF | 0.76 | 0.076 |
| GNT Shade “Intense Pink” Powder | 1.4 | 0.14 |
| Carbonated Water | 980 | 98 |

### Example 2: “Tropical Berry”-Flavored Ready-to-Drink Energy Beverage Product

A “tropical berry”-flavored ready-to-drink energy beverage product was prepared by mixing, in no particular order, the Energy Premix Powder described in Table 1 of Example 1 with Cordyceps militaris, sucralose, acesulfame potassium, citric acid, 82214 Natural Galaxy Burst Type Flavor, 82397 Natural Tropical Punch Type Flavor, Exberry Shade “Blue” Powder, and carbonated water to produce the “tropical berry”-flavored ready-to-drink energy beverage product according to the amounts in Table 3.

TABLE 3
“Tropical Berry”-flavored ready-to-drink energy beverage product

| | Weight (g) per | |
|---|---|---|
| | Liter | Percent |
| | (L) | (w/w) |
| Energy Premix Powder | 8.0 | 0.80 |
| Cordyceps militaris | 0.14 | 0.014 |
| Sucralose | 0.29 | 0.029 |
| Acesulfame potassium | 0.11 | 0.011 |
| Citric acid | 3.6 | 0.36 |
| 82214 Natural Galaxy Burst Type Flavor | 4.9 | 0.49 |
| 82397 Natural Tropical Punch Type Flavor | 0.62 | 0.062 |
| Exberry Shade “Blue” Powder | 0.75 | 0.075 |
| Carbonated Water | 980 | 98 |

### Example 3: “Blueberry Lemonade”-Flavored Ready-to-Drink Energy Beverage Product

A “blueberry lemonade”-flavored ready-to-drink energy beverage product was prepared by mixing, in no particular order, the Energy Premix Powder described in Table 1 of Example 1 with Cordyceps militaris, sucralose, acesulfame potassium, citric acid, tartaric acid, 82492 Natural Blueberry Flavor WONF, 82169 Natural Lemonade Type Flavor, Exberry Shade “Grape Blue” Powder, and carbonated water to produce the “blueberry lemonade”-flavored ready-to-drink energy beverage product according to the amounts in Table 4.

TABLE 4
“Blueberry lemonade”-flavored ready-
to-drink energy beverage product

| | Weight (g) per | |
|---|---|---|
| | Liter | Percent |
| | (L) | (w/w) |
| Energy Premix Powder | 8.0 | 0.80 |
| Cordyceps militaris | 0.14 | 0.014 |
| Sucralose | 0.29 | 0.029 |
| Acesulfame potassium | 0.11 | 0.011 |
| Citric acid | 3.6 | 0.36 |
| Tartaric acid | 0.11 | 0.011 |
| 82492 Natural Blueberry Flavor WONF | 4.9 | 0.49 |
| 82169 Natural Lemonade Type Flavor | 1.5 | 0.15 |
| Exberry Shade “Grape Blue” Powder | 0.83 | 0.083 |
| Carbonated Water | 990 | 98 |

### Example 4: “Peach Pineapple”-Flavored Ready-to-Drink Energy Beverage Product

A “peach pineapple”-flavored ready-to-drink energy beverage product was prepared by mixing, in no particular order, the Energy Premix Powder described in Table 1 of Example 1 with Cordyceps militaris, sucralose, acesulfame potassium, citric acid, 82726 Natural Peach Flavor WONF, 82713 Natural Cherry Flavor WONF, 82714 Natural Pineapple Flavor WONF, Exberry Shade “Intense Pink” Powder, Exberry Shade “Spicy Yellow” Powder, and carbonated water to produce the “peach pineapple”-flavored ready-to-drink energy beverage product according to the amounts in Table 5.

TABLE 5
“Peach pineapple”-flavored ready-to-drink energy beverage product

| | Weight (g) per | |
|---|---|---|
| | Liter | Percent |
| | (L) | (w/w) |
| Energy Premix Powder | 8.0 | 0.80 |
| Cordyceps militaris | 0.14 | 0.014 |
| Sucralose | 0.29 | 0.029 |
| Acesulfame potassium | 0.11 | 0.011 |
| Citric acid | 3.6 | 0.36 |
| 82726 Natural Peach Flavor WONF | 3.3 | 0.33 |
| 82713 Natural Cherry Flavor WONF | 1.1 | 0.11 |
| 82714 Natural Pineapple Flavor WONF | 1.5 | 0.15 |
| Exberry Shade “Intense Pink” Powder | 0.21 | 0.021 |
| Exberry Shade “Spicy Yellow” Powder | 0.42 | 0.042 |
| Carbonated Water | 990 | 98 |

Each numerical value presented herein is contemplated to represent a minimum value or a maximum value in a range for a corresponding parameter. Accordingly, when added to the claims, the numerical value provides express support for claiming the range, which may lie above or below the numerical value, in accordance with the teachings herein. Every value between the minimum value and the maximum value within each numerical range presented herein is contemplated and expressly supported herein, subject to the number of significant digits expressed in each particular range. Absent express inclusion in the claims, each numerical value presented herein is not to be considered limiting in any regard.

Having described herein illustrative embodiments, persons of ordinary skill in the art will appreciate various other features and advantages of the invention apart from those specifically described above. It should therefore be understood that the foregoing is only illustrative of the principles of the invention, and that various modifications and additions, as well as all combinations and permutations of the various elements and components recited herein, can be made by those skilled in the art without departing from the spirit and scope of the invention. Accordingly, the appended claims shall not be limited by the particular features that have been shown and described, but shall be construed also to cover any obvious modifications and equivalents thereof.

1. A ready-to-drink energy beverage product comprising (per liter):
0.001 to 1.5 g of Cordyceps militaris;
0.1 to 1.0 g of caffeine;
0.01 to 0.25 g of vitamin B;
less than 1.0 g of sugar; and
945 to 998 g of water.

2. The beverage product of claim 1, comprising 0.01 to 1.0 g (per liter) of Cordyceps militaris.

3. The beverage product of claim 1, comprising 0.1 to 0.5 g (per liter) of Cordyceps militaris.

4. The beverage product of claim 1, comprising 0.14 g (per liter) of Cordyceps militaris.

5. The beverage product of claim 1, comprising 0.28 g (per liter) of Cordyceps militaris.

6. The beverage product of claim 1, comprising 0.25 to 0.75 g (per liter) of caffeine.

7. The beverage product of claim 1, comprising 0.6 g (per liter) of caffeine.

8. The beverage product of claim 1, comprising 0.025 to 0.1 g (per liter) of vitamin B.

9. The beverage product of claim 1, comprising 0.08 g (per liter) of vitamin B.

10. The beverage product of claim 1, comprising less than 0.5 g (per liter) of sugar.

11. The beverage product of claim 1, comprising no sugar.

12. The beverage product of claim 1, comprising 2.5 to 7.5 g (per liter) of taurine.

13. The beverage product of claim 1, comprising 3 g (per liter) of taurine.

14. The beverage product of claim 1, comprising 1.0 to 5.0 g (per liter) of glucuronolactone.

15. The beverage product of claim 1, comprising 1.5 g (per liter) of glucuronolactone.

16. The beverage product of claim 1, further comprising an artificial sweetener.

17. The beverage product of claim 16, comprising 0.1 to 1.0 g (per liter) of sucralose.

18. The beverage product of claim 16, comprising 0.3 g (per liter) of sucralose.

19. The beverage product of claim 16, comprising 0.05 to 0.5 g (per liter) of acesulfame potassium.

20. The beverage product of claim 16, comprising 0.1 g (per liter) of acesulfame potassium.

21. The beverage product of claim 1, further comprising 1.0 to 5.0 g (per liter) of citric acid.

22. The beverage product of claim 21, comprising 3.6 g (per liter) of citric acid.

23. The beverage product of claim 1, further comprising 0.01 to 0.15 g (per liter) of tartaric acid.

24. The beverage product of claim 23, comprising 0.1 g (per liter) of tartaric acid.

25. The beverage product of claim 1, further comprising at least one flavoring selected from the group consisting of 82724 Natural Unicorn Type Flavor, 82270 Natural Cotton Candy Type Flavor, 82000 Natural Orange Flavor WONF, GNT Shade “Intense Pink” Powder, 82214 Natural Galaxy Burst Type Flavor, 82397 Natural Tropical Punch Type Flavor, Exberry Shade “Blue” Powder, 82492 Natural Blueberry Flavor WONF, 82169 Natural Lemonade Type Flavor, Exberry Shade “Grape Blue” Powder, 82726 Natural Peach Flavor WONF 82713 Natural Cherry Flavor WONF, 82714 Natural Pineapple Flavor WONF, Exberry Shade “Intense Pink” Powder, and Exberry Shade “Spicy Yellow” Powder.

26. The beverage product of claim 1, wherein the water is carbonated and comprises 1 to 10 g (per liter) of CO₂.
